(19) United States
(12) Patent Application Publication
(10) Pub. No.: US 2012/0284159 A1
(43) Pub. Date: Nov. 8, 2012

(54) FINANCIAL TRADING SYSTEM AND METHOD UTILIZING HOTKEY SUBSCRIPTIONS

(75) Inventor: Adam Sheldon, Chicago, IL (US)

(73) Assignee: Bionic Trader Systems, LLC

(21) Appl. No.: 13/103,057

(22) Filed: May 7, 2011

(51) Int. Cl. G06Q 40/00

(52) U.S. Cl. 705/37

(57) ABSTRACT

A system for managing hotkey subscriptions includes one or more controllers adapted to run two or more software applications, including a trading software application, wherein the trading software application includes one or more functions associated with a respective one or more hotkeys and further wherein the one or more controllers are configured to inform the trading software application when any of the hotkeys are triggered anytime the trading software application is running. A method for managing hotkey subscriptions includes the steps of: concurrently running two or more software applications, including a first trading software application including one or more functions associated with a respective one or more hotkeys; and informing the first trading software application when any of the hotkeys are triggered, anytime the trading software application is running.

### BACKGROUND OF THE INVENTION

The present subject matter relates to financial trading software which is configured to execute functions associated with hotkeys anytime the trading software application is running on the computer. Further, the systems and methods disclosed herein enable easy to manage and implement hotkey subscriptions.

There are many types of financial market traders in the world; however, for simplicity they may generally be segregated into two groups: program traders and discretionary traders. Program traders typically program their computers to trade automatically based on predetermined criteria. Discretionary traders typically enter their trades manually, based on criteria they may think of ahead of time, based on split second decision making, or a combination of both. The subject matter disclosed herein focuses on discretionary traders.

There are certain obvious factors that help determine how successful discretionary financial markets traders can be: the time they take to do research and to study technical data and charts, the quality of their technical equipment, the quality of their connection to brokerage and/or exchange, the speed of their market data, the quality and speed of their trading software, the quality and timeliness of the market news they receive, the features and functionality offered as part of their trading software, and other obvious factors, such as intelligence, experience, and their talent in the field.

There are also less-obvious factors that play a role in the level of success of a discretionary financial markets trader: the ability to focus on the market, the ability to tune out distraction, the speed and consistency of the order entry process, the speed and consistency of other processes incorporated within the trading software, and other factors. Note that these less-obvious factors are presumed to correlate to trading success to the extent that the trader is active; the profit and loss of a relatively inactive trader will not correlate too strongly to these less-obvious factors as much as the profit and loss of an active trader will. Put another way, to the extent to which a discretionary trader is active, the ability to focus and execute methods in a fast and predictable manner becomes more important.

Discretionary traders may be further separated into two groups—discretionary traders that trade using a mouse, and discretionary traders that trade using a keyboard. There are other possible ways to trade, but these are the main groups. Generally, most of the features and functionality that are offered by trading software vendors target discretionary traders who trade with a mouse, more than discretionary traders who trade with a keyboard. There are many possible reasons for this, such as the fact that a mouse may be easier to use and understand for new users of a system, and such as the fact that most users are already very comfortable using a mouse but less comfortable trading with keyboard. Further, trading software firms are typically unassociated with keyboard manufacturers and computer makers. Therefore, trading software firms may not make it part of their business to understand how their software will interact with hardware, such as keyboards. Trading software vendors may simply have been taking the more direct and obvious approach.

It should be noted that in order for traders to trade with a keyboard, they must first either devote an area of a QWERTY keyboard to their trading methods (such as, for example, the F1-F12 function keys, the lettered or numbered keys, or a combination of these or any other keys), or they may buy a programmable keyboard. If traders use a programmable keyboard, they must also map the programmable keys to the desired function, i.e., program what each key on the programmable keyboard should trigger, such as specifying that the key to the bottom right of the keyboard, if pressed, will trigger the key “X” or the combination of “Cntl-U”. Traders must also assign functions within the trading software directly to key strokes, in order to specify what functions should run whenever a key or key combination is executed. As can be seen, multiple processes may be required for a trader to trade with a keyboard. In contrast, a trader using a mouse simply has to plug in the mouse, and then click on functionality offered to them on the GUI within the trading software. As can be seen, the process of trading with a keyboard is significantly more complex to set up than the process of trading with a mouse. This is probably a main reason why trading software vendors have typically targeted mouse users with their trading software interfaces.

Just about any key stroke or other user input action can be associated to a function or action or set of actions within a trading software platform, as long as the function is available to be programmed to be triggered by a user action by the trading software platform. Typically, most trading software vendors offer a certain number of functions that may be programmed to be triggered by a user action, and it is typically up to the user to assign the user actions to functions triggered. However, it is understood that in some cases, the functions are associated with specific user actions by default. As described herein, functions may be single-step functions, or multiple-step functions typically called macros.

As used herein, the term “hotkey” refers to any one or combination of multiple user input actions, the execution of which may trigger a resulting action. Each hotkey may be associated with a resulting function within software by default or by user-direction. Within trading software, there may be no hotkey associated with a trading function, or there may be one or more default hotkeys associated with a trading function, and the user may be able to adjust the assignments of hotkeys to various trading functions. In some trading software, users may possibly be able to create or adjust the trading functions to which hotkeys may be associated. It should be noted that a hotkey may be any individual key on a keyboard (such as, for example, a single letter or number), or any combination of keys (such as, for example, Cntl-Alt-Y or Shift-2). Further, it should be noted that the term hotkeys may refer to any other user input, or combination of user inputs, the execution of which is programmed to trigger a function within software. For example, the term “hotkey” may refer to functions triggered by actions associated with other input devices, such as desktop buttons, foot pedals, handheld devices, and other methods.

Presently, certain problems with existing technologies and gaps (or errors) in the typical methodologies offered by trading software vendors often make trading with a keyboard difficult for discretionary traders. By delving into more detail, these problems start to become apparent. These problems are most obvious when a trader has multiple applications, including the trading platform, running on the same computer at the same time. In discussing these problems, the term “secondary application” refers to any software application other than the trading software. Further, an “active application” is a software application which may have been the last application used, the application which may be highlighted in the user interface, or the application which is otherwise active in some way. An “inactive application” is not the current application in use, may not be highlighted in the user interface, or may otherwise be inactive. To further help differentiate between active and inactive applications, if a user has two or more applications running on a computer at the same time, most typically, when one software application is activated, all of the others become inactive. As used herein, one program may comprise multiple processes. Accordingly, reference to a program refers to the set of processes that are associated with that program, such that they are typically installed as a group, working as a group, etc.

In one example, any time a user activates an application, the application which was previously active becomes inactive. There are typically a few ways to tell which application is active on the computer; one of the most obvious ways is by looking at the title bar of the application, which will usually appear one way for active applications and another way for inactive applications, depending on the operating system and user settings. It should also be noted that even if a secondary application is not active, it is possible for the trading software to be inactive, such as may be the case if the user has just left-clicked his mouse on the desktop, or possibly right-clicked the mouse on the desktop, possibly showing a menu of items that may be selected. In this way, the trading software application may be inactive even if there is no obvious active secondary application.

Typically, when the trading software is the active application on the computer, if a user triggers one or more hotkeys, the hotkeys trigger functions in the trading software. However, if the trading software is inactive (and users may not always check if the trading software is an active application before executing a hotkey, especially during the high stress of active trading), the hotkeys do not trigger actions on the trading software. Instead, the hotkeys operate as keystrokes in the secondary application, if one exists, trigger other actions on the computer or produce no result. As a result, the execution of a given keystroke may result in an unexpected response by the system. Accordingly, users may be less confident that when they execute a hotkey the desired function will be executed, especially when they may not be 100% sure which application, if any, is active. For users of most types of software products, this type of unexpected behavior might not be a problem. However, for discretionary financial market traders using trading software a single unexpected action or inaction may be very costly. This is specifically because predictability and consistency in the order entry process are so important. Other types of functionality within trading software platforms may also be very important and time-sensitive as well. Discretionary traders who use a keyboard to trade with need to know that whenever they are actively trading, that if they execute hotkeys, that the associated actions they have defined on their trading software will be triggered. However, more broadly, discretionary traders need to have confidence in the consistency of their order entry methods and other methods that may be possible within trading software.

Discretionary traders usually fill their hours staring at market data and listening to news and squawk boxes at the same time. Whether intended or unintended, traders quite frequently deactivate (make inactive) the trading software, whether all of its associated windows and GUIs remain visible or not. Accordingly, there are often times that a discretionary trader may not be aware of whether their trading software is an active application or not. In fact, realistically the trader may not be aware of which application is the active application most of the time. Correspondingly, there are frequently times when a trader executes a hotkey, expecting to trigger a function on the trading software (such as, for example, to send an order to market), but the execution of the hotkey has no effect, or an unintended effect, because the trading software is inactive. What traders need is predictability and consistency in their trading software. Most important, traders need to know that when they are actively trading, then when they execute a hotkey on their computer, that the hotkey will trigger the intended actions, and that these results will happen all of the time, and will not depend on the application state of the trading software.

Essentially, discretionary traders who trade using hotkeys do not have the comfort of time, nor do they have unlimited mental capability, to be able to check whether the trading software is active before they submit each hotkey. Nor do they have the time, in the case that the trading software is inactive, to actually activate the trading software. Any such disruptions are likely to translate directly into losses or missed opportunities for traders. The steps of having to check whether the trading software is active, and possibly to activate the trading software before executing a hotkey, are time consuming steps, and they are so annoying and unnecessary that they make the entire process of using hotkeys to trade with difficult and filled with unexpected results, especially when the trader does not perform the required steps each and every time they wish to execute a hotkey. In cases where traders do not check whether the trading software is active or not, they may think they have sent orders to market, only to find out later that the position they thought they had in the market was incorrect because the actions they expected to get triggered never occurred. Regardless of how the various scenarios may play out, whenever a trader makes a mistake due to the discussed problem of the trading software being inactive, there is a loss of time and a loss of opportunity for action. Neither can be replaced.

In addition to the problems associated with the use of hotkeys within active and inactive applications described above, there are additional problems related to activating and deactivating hotkey functionality.

There are trading platforms that allow the assignment of hotkeys for order placement and other functionality. However, in many of these trading platforms, once hotkeys have been assigned and hotkey subscriptions are turned on, if turning them on is an intermediate step, then turning off the hotkey subscriptions is either difficult or impossible.

Typically, the methods available today for turning hotkey subscriptions on or off within trading software requires the user to open user forms and make adjustments to the settings, which is usually annoying and time consuming while the market is open. Even when the user is able turn on or off the hotkey subscriptions for the entire platform fairly easily (i.e., with one user action), there is no control for quickly turning on or off hotkey subscriptions for a subset of the hotkeys assigned to functionality within the trading platform. Trading software on the market today has not allowed users to turn on or off hotkey subscriptions assigned to one tradable instrument. This is a significant omission, and can lead to huge mistakes on the part of the trader. It should be noted that if a user absolutely needed to unsubscribe from hotkeys for just one tradable instrument (but not the entire set of hotkeys for the entire trading platform), the only way they could do so using existing trading software would be to manually remove every single hotkey for every single function. This could take a lot of time, and would even require more time when the user had to re-assign all the keys again. If a user wants to unsubscribe from 20 or 50 hotkeys assigned to a tradable instrument while leaving all other hotkey subscriptions in the platform active, the removal of hotkeys would have to be done manually for every single function for the tradable instrument, only to have to be re-assigned manually later as well. The process may be very time consuming.

The term “tradable instrument” or “tradable instruments” may refer to stocks, bonds, currencies, commodities, warrants, options, futures, spreads, synthetics, FOREX contracts, as well as any other type of tradable instrument, Further, other types of tradable instruments not specifically mentioned herein, or developed in the future, shall also be included as part of the term “tradable instrument” or “tradable instruments.”

Accordingly, the technologies and methods that exist within trading software on the market today do not adequately serve the needs of discretionary traders who trade using hotkeys. What traders need is trading software which will execute functionality assigned to hotkeys within the trading software, regardless of which software application is active on the computer when hotkeys are executed on the machine. Without this functionality, methods of using hotkeys to trade with are inherently flawed. Further, traders need a quick and easy way to turn on and off hotkey subscriptions within the described system, i.e., an easy way to turn on and off whether the trading software will execute functions associated with their respective hotkeys, thereby allowing the software to execute the functionality tied to the hotkeys when the hotkey subscriptions are on, but not to execute the functionality when they are off. Further, traders also need to be able to turn on and off hotkey subscriptions specific to one or more tradable instruments, as well as other subsets of the hotkeys assigned to functionality within the trading software, without influencing all of the other remaining hotkey subscriptions defined in the trading software at the same time.

### BRIEF SUMMARY OF THE INVENTION

In order to overcome the problems associated with the prior art, the present subject matter discloses systems and methods in which trading software executes the action(s) associated with a given hotkey as long as the trading software is running on the computer, when the hotkey is submitted. In addition, the present subject matter discloses systems and methods in which sets and subsets of the hotkey subscriptions may be turned on and off, to allow the execution of functionality assigned to hotkeys when wanted, and to prevent the execution of functionality assigned to hotkeys when not wanted, in some instances with a single user action.

Because in most scenarios, the trading software executes the functionality assigned to the hotkey which has been triggered, the descriptions herein often rely on shorthand to improve readability. The commonly used shorthand is that when a hotkey is triggered on the machine, the functionality assigned to the hotkey is executed in the trading software (if the hotkey subscription is on). However, it is expected to be understood that this short hand description includes embodiments in which the trading software is first informed that a hotkey has been triggered and then executes the functionality assigned to the hotkey as well as embodiments n which the trading software is first informed that a hotkey has been triggered and then selectively executes the functionality assigned to the hotkey. Note that other deviations/iterations of this shorthand may be used in this description, and the explanation provided here applies to these other versions as well.

For example, in certain embodiments of the systems and methods, users may turn on or off subscriptions to all of the hotkeys assigned to a particular tradable instrument as a group, as well as any other subset of all of the hotkeys assigned within the trading software, without affecting the remainder of the hotkeys in the trading software. Accordingly, one or more subsets of hotkeys may be functional while their subscription is on and may be non-functional while their subscription is off, while the status of the remaining hotkeys in the application is unaffected.

The systems and methods provided herein allow quicker and easier hotkey subscription management. For example, in some embodiments, a single user action may turn on or off hotkey subscriptions for a tradable instrument. In other embodiments, the user may turn on or off hotkey subscriptions for one or more or all tradable instruments within the trading software, one or more or all functions within the trading software, all of the functionality in the trading software, or some other subset of the functionality in the trading software. Accordingly, a user may choose to unsubscribe to hotkeys for a tradable instrument the trader no longer wants to trade, but stay subscribed to hotkeys for other tradable instruments the trader wishes to trade. Quick order execution may be maintained for tradable instruments the trader wishes to continue trading, while errors may be prevented for tradable instruments the trader no longer wishes to trade. When the trader changes his or her mind about what tradable instruments to trade, the trader may simply turn on or off the hotkey subscriptions for any tradable instrument-at any time using one input method, such as a mouse-click or keystroke. As a result, hotkeys do not have to be reassigned to each function for each tradable instrument when they are turned on, but rather the hotkey subscriptions that have already been assigned, but have simply been inactive, may be turned on as a whole for the tradable instrument (or some other subset) with a simple input command.

There are numerous reasons that the ability to turn hotkey subscriptions on and off easily is valuable. In one example, once the hotkeys subscriptions have been turned off within the trading software, the hotkeys (or simple keys) may be used in other software without the user having to worry about possibility of sending orders by mistake. For example, a user that wants to leave the trading software open, just in case he or she wishes to trade with short notice in the future, but temporarily work in Microsoft Excel until that moment to start trading may occur, may wish to turn off the hotkey subscriptions within the trading software in order to work in Microsoft Excel worry-free.

To continue the example, remember that trading is a very time-sensitive profession. It is expected that when a trader sees an opportunity in the market, he or she may want to enter the market as quickly as possible, using the hotkey-based order entry system. Towards this goal, the ease with which the hotkey subscriptions may be activated and deactivated is highly advantageous.

A system for managing hotkey subscriptions includes one or more controllers adapted to run two or more software applications, including a trading software application, wherein the trading software application includes one or more functions associated with a respective one or more hotkeys and further wherein the one or more controllers are configured to inform the trading software application when any of the hotkeys are triggered anytime the trading software application is running. The two or more software applications may include a second software application other than the trading software application that includes one or more overlapping hotkeys. In some embodiments, the second software application is not informed when the one or more overlapping hotkeys are triggered. In other embodiments, both applications are informed when the overlapping hotkeys are triggered.

Through hotkey subscriptions, the system may be configured in a first state to execute the one or more functions associated with the respective one or more hotkeys when the hotkeys are triggered and in a second state to not to execute the functions associated with hotkeys when the hotkeys are triggered. The hotkey subscriptions may be activated based on one or more conditional tests, including conditional logic tests, user selected conditions. For example, the hotkey subscriptions may be automatically toggled on and off based on conditional logic tests. In other examples, the hotkey subscriptions may be toggled on and off by a user making a selection in the trading software through the user interface. Further, the functions associated with hotkeys may divided into two or more subsets, wherein each of the subsets of hotkeys may be independently toggled between the first state and the second state.

A method for managing hotkey subscriptions includes the steps of: concurrently running two or more software applications, including a first trading software application including one or more functions associated with a respective one or more hotkeys; and informing the first trading software application when any of the hotkeys are triggered, anytime the trading software application is running. In some embodiments, the method may further include the step of executing the triggered one or more hotkeys anytime the trading software application is running. In alternative embodiments, the method may further include the step of conditionally executing the triggered one or more hotkeys. The triggered one or more hotkeys may be selectively executed based on one or more conditional tests, may be are automatically selectively executed based on one or more conditional tests, such as conditional logic tests or user selected conditions.

Additionally, the functions associated with hotkeys may be divided into at least two subsets, wherein each of the subsets of hotkeys may independently be toggled between a first state in which the associated hotkey subscriptions are on and a second state in which the associated hotkey subscriptions are off.

Computer readable media including computer-executable instructions for managing hotkeys subscriptions, may be provided to cause a system to perform the steps of: concurrently running two or more software applications, including a first trading software application including one or more functions associated with a respective one or more hotkeys; and informing the first trading software application when any of the hotkeys are triggered, anytime the trading software application is running. The computer-executable instructions may further cause the system to perform the steps of executing the triggered one or more hotkeys anytime the trading software application is running.

Accordingly, it is an advantage of the systems and methods disclosed herein to provide a trading system in which the functions associated with subscribed hotkeys are executed when triggered, anytime the trading software application is running on the computer.

It is another advantage of the systems and methods disclosed herein to provide a system including hotkey subscription functionality that enables a user to selectively turn on and off subsets of the hotkey subscriptions.

It is yet another advantage of the systems and methods disclosed herein to provide a system in which aspects of the hotkey subscription management may be controlled via a single user action.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 illustrates a schematic view of a system according to the present invention.

FIG. 2 is a screen shot displaying an example of a display while only the trading software is running in the system.

FIG. 3 is a screen shot displaying another example of a display while only the trading software is running in the system.

FIG. 4 is a screen shot displaying an example of a display while multiple software applications are running in the system.

FIG. 5 is a screen shot displaying another example of a display while multiple software applications are running in the system.

FIG. 6 is a screen shot displaying another example of a display while only the trading software is running in the system.

### DETAILED DESCRIPTION OF THE INVENTION

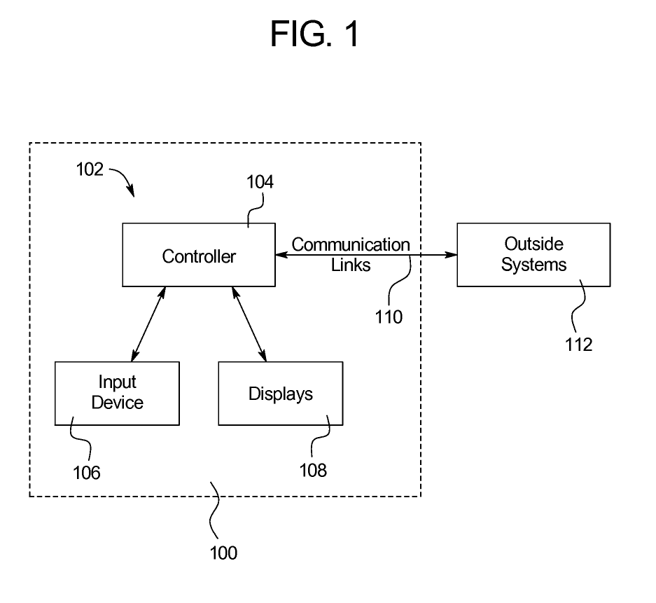

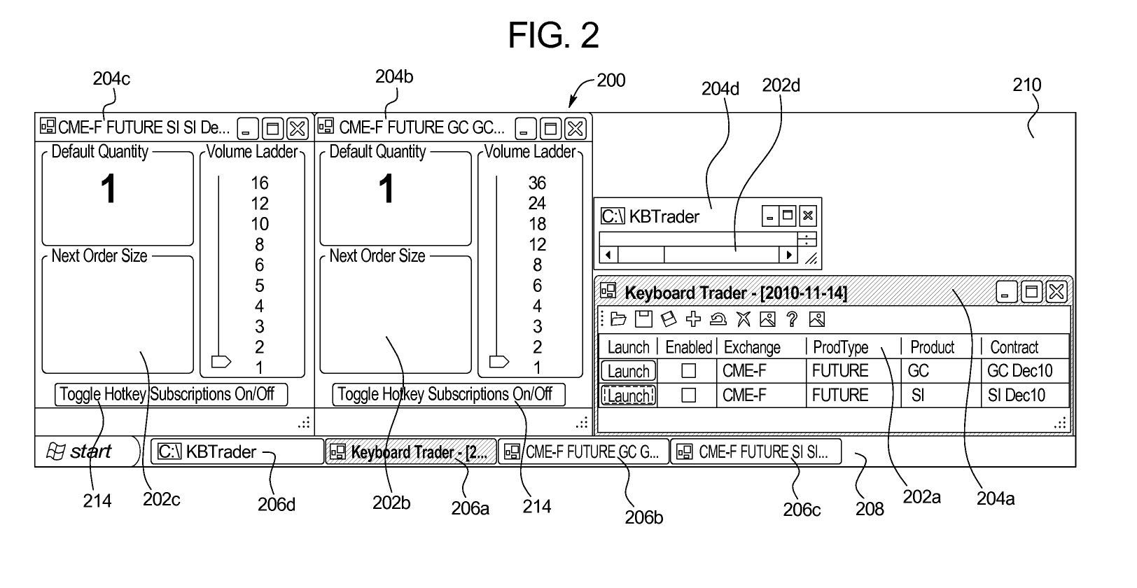

FIG. 1 illustrates an example of a system 100 in which trading software 102 executes the action(s) associated with a given hotkey, anytime the trading software 102 is running in the system 100, when the hotkey is submitted. Further, the trading software 102 includes hotkey subscription functionality that enables a user to selectively turn on and off subsets of the hotkey subscriptions. As shown in FIG. 1, the system 100 includes one or more controllers 104 that receive user commands from one or more input devices 106 and output visual information to one or more displays 108. As further shown, the system 100 includes one or more communication links 110 for communicating with financial trading markets and other outside systems 112. Examples of the functionality provided by the system 100 are further described with reference to FIGS. 2-6 herein.

Herein, the terms “hotkey subscription” and “hotkey subscriptions” are used to refer to whether or not functions associated with a respective hotkey are to be executed (or conditionally executed) after the hotkey has been triggered.

In the system 100 provided herein, hotkey subscriptions may be turned on or off for the entire set of hotkeys assigned to functionality within the trading software 102, or for a subset of all the hotkeys assigned to functionality within the trading software 102. The term “set of hotkeys” refers to a set of hotkeys assigned within the trading software 102, or a subset of hotkeys assigned within the trading software 102.

In many scenarios, when hotkey subscriptions are on for a set of hotkeys assigned to functionality within the trading software 102, then after the trading software 102 is informed that a hotkey within this set has been triggered, the trading software 102 executes the functionality assigned to the hotkey that has been triggered. In other scenarios, the trading software 102 may be configured such that when hotkey subscriptions are on for a set of hotkeys assigned to functionality within the trading software 102, then after the trading software 102 is informed that a hotkey within this set has been triggered, the trading software 102 selectively executes the functionality assigned to the hotkey that has been triggered. The selective execution of the hotkey functionality may be based on condition testing, such as an “if/else” test, options assigned by the user, etc.

Aspects of the system 100 shown in FIG. 1 are controlled by one or more controllers 104. The one or more controllers 104 may run a variety of application programs (such as, for example, the trading software 102), may access and store data, including accessing and storing data in associated databases, and may enable one or more interactions via the input devices 106 and displays 108. Typically, the one or more controllers 104 are implemented by one or more programmable data processing devices. The hardware elements operating systems and programming languages of such devices are conventional in nature, and it is presumed that those skilled in the art are adequately familiar therewith.

For example, the one or more controllers 104 may be a PC based implementation of a central control processing system utilizing a central processing unit (CPU), memories and an interconnect bus. The CPU may contain a single microprocessor, or it may contain a plurality of microprocessors for configuring the CPU as a multi-processor system. The memories may include a main memory, such as a dynamic random access memory (DRAM) and cache, as well as a read only memory, such as a PROM, an EPROM, a FLASH-EPROM, or the like. The system may also include mass storage devices such as various solid-state drives, disk drives, tape drives, etc. In operation, the main memory may store at least portions of instructions for execution by the CPU and data for processing in accord with the executed instructions.

The one or more controllers 104 may also include one or more communication links 110 which provide input/output interfaces for communications with one or more processing systems. The communication links 110 may enable communications via a network, e.g., to enable sending and receiving instructions electronically. The communication links 110 may be wired or wireless. For example, the communication links 110 may be used to communicate with a brokerage and/or exchange.

The one or more controllers 104 may further include appropriate input/output ports for interconnection with the one or more displays 108 (e.g., monitors, printers, etc.) and the one or more input devices 106 (e.g., keyboard, desktop button, foot pedal, handheld device, mouse, voice, touch, bioelectric devices, magnetic reader, RFID reader, barcode reader, etc.). For example, the one or more controllers 104 may include or be connected to a graphics subsystem to drive the displays 108. The links to the peripherals may be wired or wireless connections.

Although summarized above as a PC-type implementation, those skilled in the art will recognize that the one or more controllers 104 also encompasses systems such as host computers, servers, workstations, network terminals, and the like. In fact, the use of the term controller 104 is intended to represent a broad category of components that are well known in the art.

Aspects of the system 100 encompass hardware and software for controlling the relevant functions. Software may take the form of code or executable instructions for causing the one or more controllers 104 or other programmable equipment to perform the relevant steps, where the code or instructions are carried by or otherwise embodied in a medium readable by the one or more controllers 104 or other machine. Instructions or code for implementing such operations may be in the form of computer instruction in any form (e.g., source code, object code, interpreted code, etc.) stored in or carried by any readable medium.

Turning now to FIG. 2, a screen shot 200 is illustrated providing an example of a display 108 while only the trading software 102 is running in the system 100. In the example shown in FIG. 2, there are four windows 202a-202d displayed. In this example, each of these four windows 202a-202d is a component of the trading software 102. It is understood that a given trading software application 102 may or may not include multiple windows 202. In the example shown in FIG. 2, a first window 202a is the active window 202. The first window 202a is identified as the active window by the highlighted title bar 204a (shown as a darker shade of gray than the other windows). In addition to the shading on the title bar 204a of the first window 202a, there is also shading on the associated window tab 206a displayed in the taskbar 208. Depending on the operating system used in the system 100, and possibly on the trading software 102 or other applications, the methodology of indicating which application is active may vary. Note that the different shading (or other active application indicia) may be easy to spot, or difficult to spot, depending where the user is focused on the screen, and also depending on other factors, such as the gradient of the coloring, and also on the strength of a user's eyes.

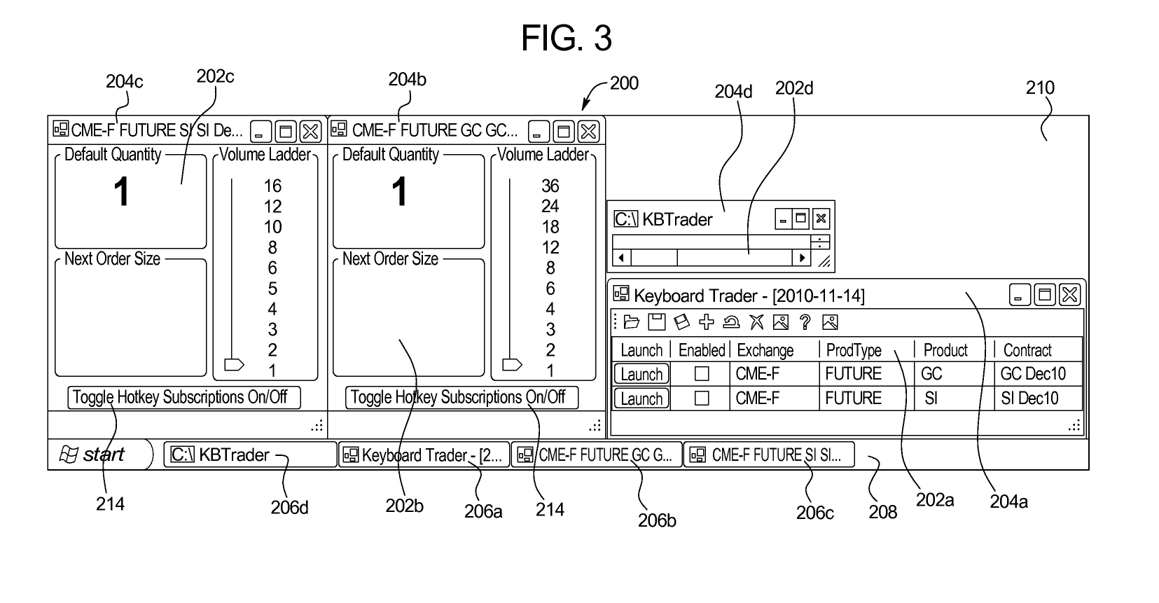

Turning now to FIG. 3, the same four windows 202a-202d that were illustrated in FIG. 2 are once again illustrated. However, note that in FIG. 3, none of these windows 202a-202d are indicated as active; none of the title bars 204a-204d of the windows 202a-202d are highlighted; further, none of the items in the taskbar 208 are highlighted either. The condition shown may be because the user has left-clicked the desktop 210, or possibly done something else, intentionally or unintentionally to cause all of the trading software windows 202a-202d to become inactive. Accordingly, FIG. 3 is an example in which there is only one application running in the system 100, the application is inactive. As is shown in the example in FIG. 3, even if the trading software 102 is the only open application, this does not mean it is an active application. In this example, it may be considered that no application is active.

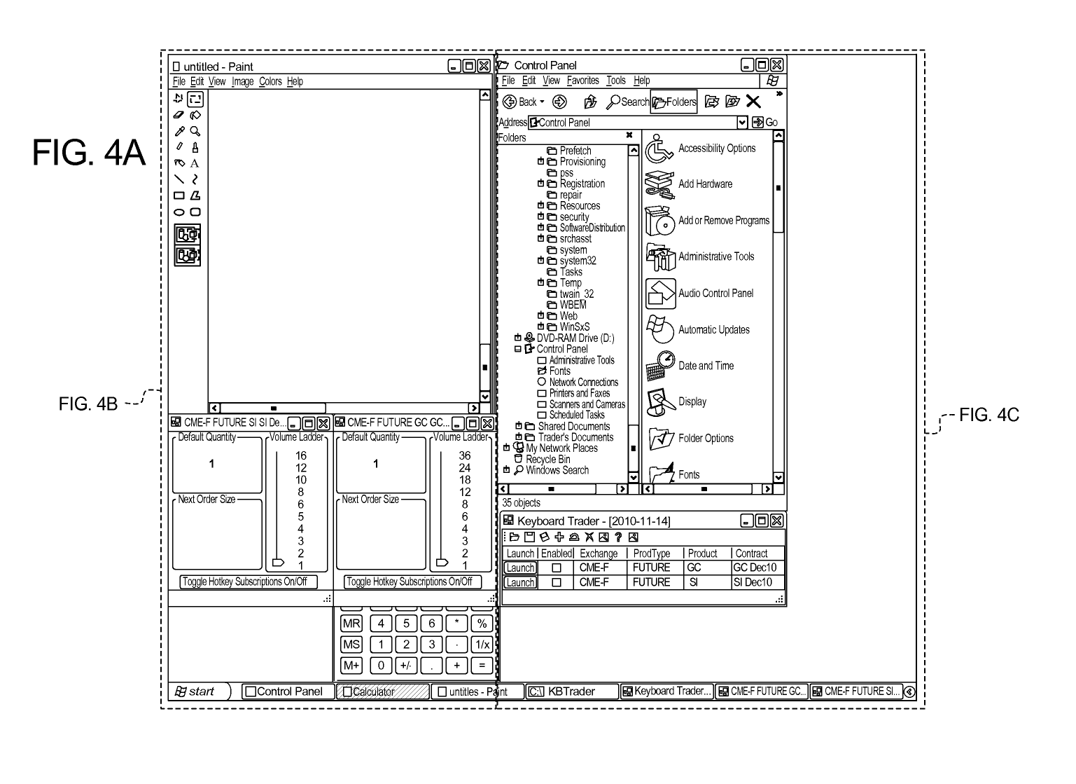

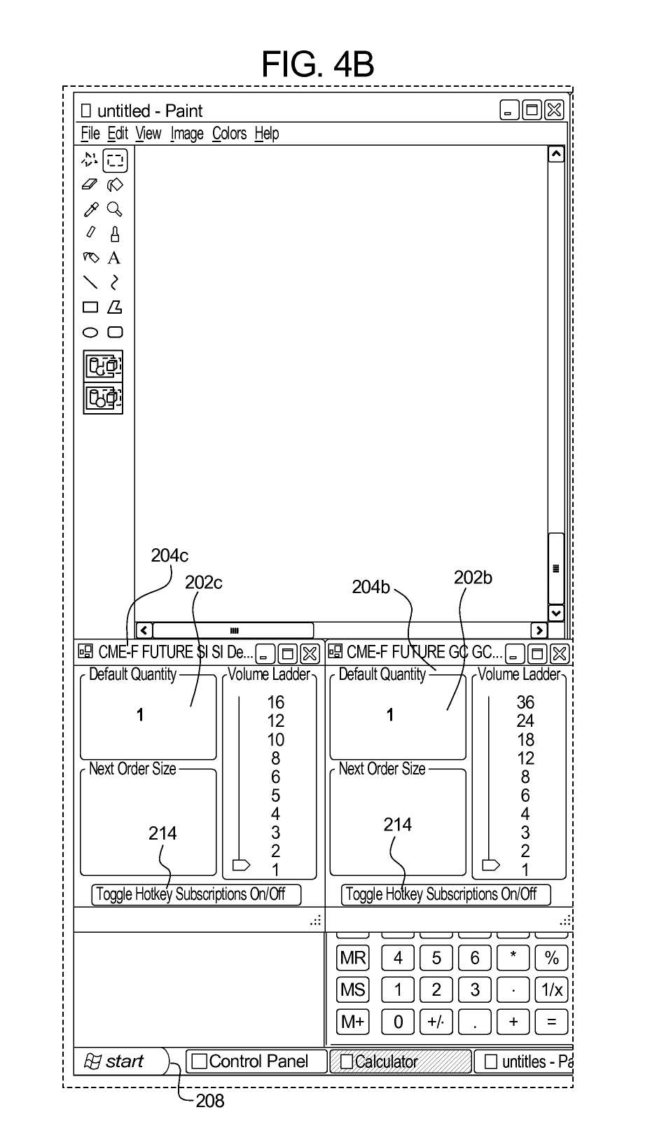

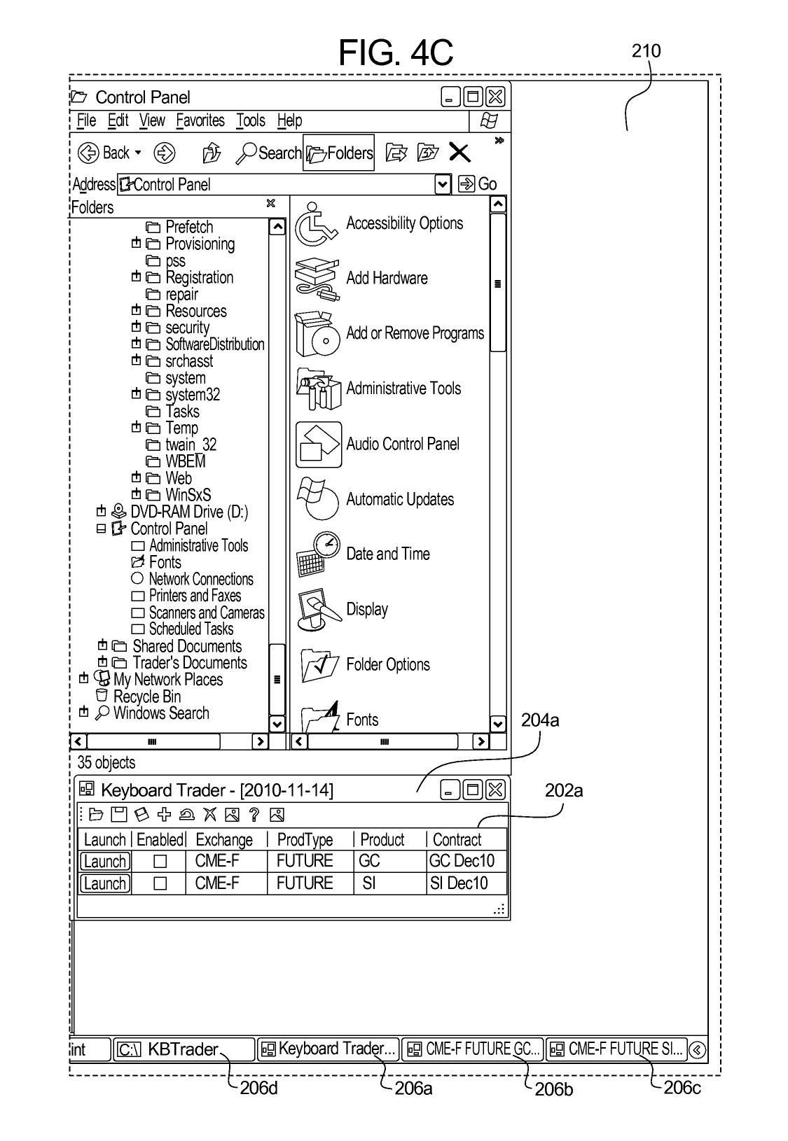

Turning now to FIG. 4, in the example shown in FIG. 4, there are multiple applications running concurrently on the system 100. In this example, the trading software 102 is an inactive application; meanwhile, the application named “Calculator” is an active application. As shown, the title bar of the “Calculator” application is hidden behind one of the windows 202b in the trading software. This may be a common occurrence in situations where a window may have the “Always On Top” or similar setting applied; however, there are a number of ways in which the scenario illustrated in FIG. 4 may occur. (The “Always On Top” setting allows a window 202 to remain visible even if another window 202 may be active behind it.)

The title bar of the “Calculator” application is hidden in the example shown in FIG. 4 to demonstrate how using title bars 204 to determine which application, if any, may be active, can be an error-prone process. In the example shown in FIG. 4, the title bar 204 for the active application cannot even be seen. Therefore, if the user had been accustomed to scanning the display 108 for the “active title bar,” the user might be searching for quite a long time. Although the active application is indicated in the taskbar 208, financial market traders may stand to make or lose significant money, based on whether they can execute orders within a fraction of a second. Even one quarter of a second delay in order placement may cost a trader significant money. This is one of many reasons that traders must be able to execute all of their hotkeys without having to think about which application is active.

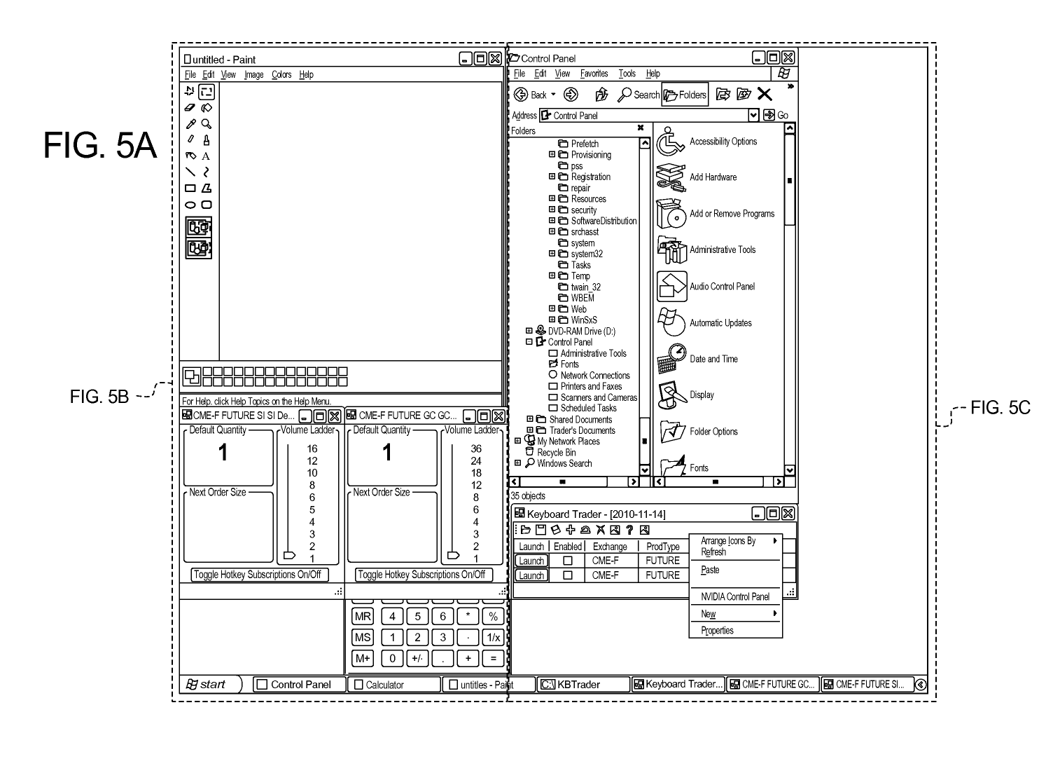

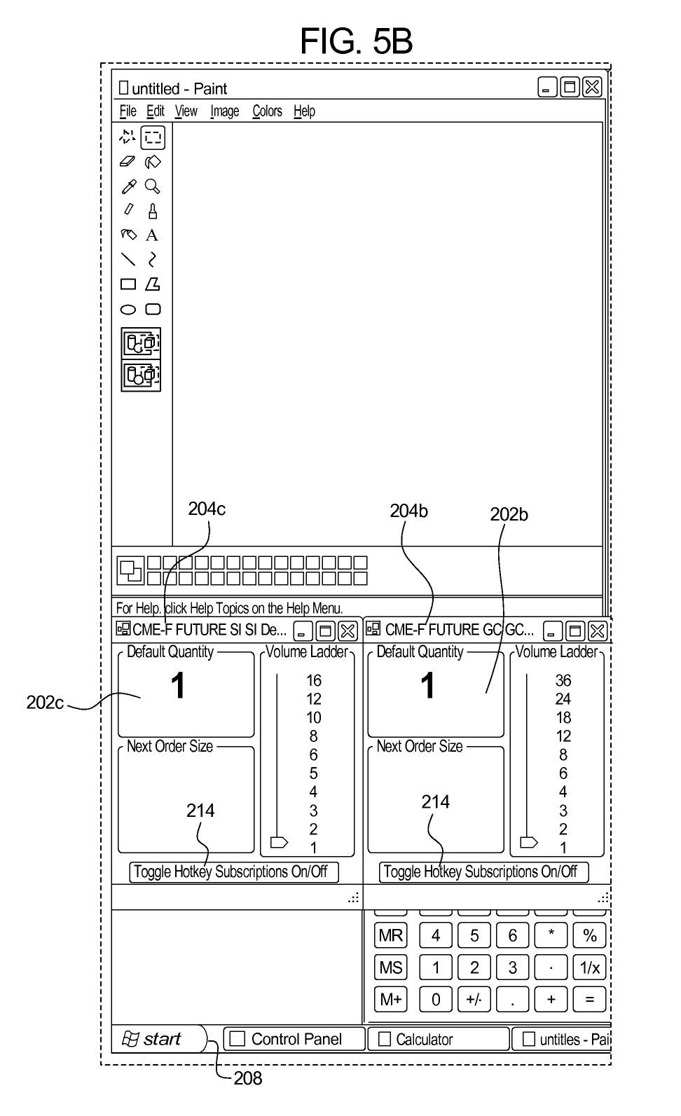

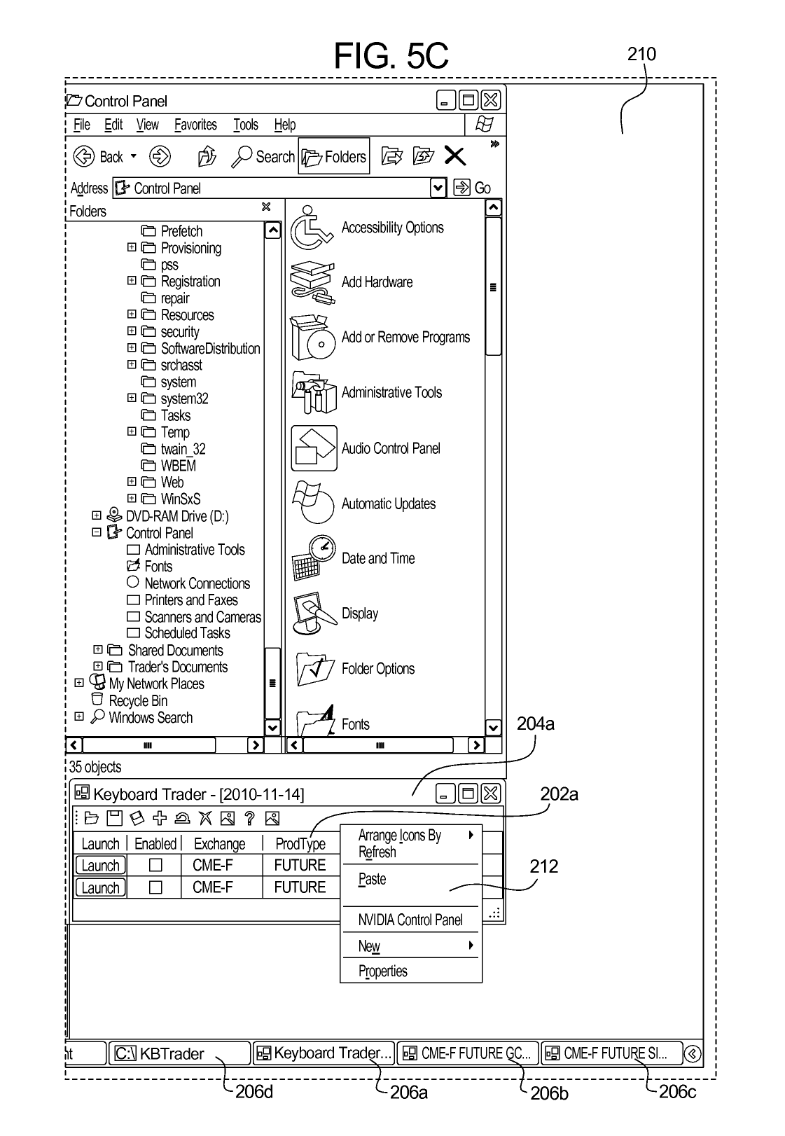

In the example shown in FIG. 5, the user has just right-clicked the desktop 210 and a menu 212 is displayed. The trading software 102 may therefore be considered to be an inactive application. This scenario may be considered very similar to the example shown in FIGS. 3 and 4, simply because the trading software 102 is not active.

Even though in all of the examples given the user would be able to tell which, if any, application was active, this may not hold true for all systems 100. In addition, there are instances in which another application may assert itself as an active application, even when the user has no such intention to activate the program. This may happen quite regularly with applications such as virus protection, firewall protection, email, operating system updates, and other applications. In these situations the trader may think the trading software 102 is an active application when it is not. As such, a trader may try to submit orders or other commands via use of hotkeys, but the attempt to execute the hotkeys will lead to no action within the trading software 102. Such unintentional deactivation of the trading software 102 can be a huge problem.

Similarly, in other scenarios it is possible that the trading software 102 may actually be an active application without the trader knowing. Consider situations where message boxes or alerts may occasionally appear within trading software 102. When utilizing multiple displays 108, the message boxes or alerts may be on a second or third monitor 108 which may be turned off, such as in a situation where the trader may have taken a break from trading. Further, the user may not have done anything personally to cause their trading software 102 to become active, but yet it may become active. Therefore, in such situations, a trader may press hotkeys on their system 100 and these hotkeys may unintentionally trigger orders or perform other actions within their trading software 102, maybe even without the trader knowing such orders actions were performed. This may even be a more dangerous scenario than those where traders may think their trading software 102 is an active application when in fact it isn't.

For example, imagine a scenario in which a trader has three of their four monitors 108 turned off, and further in which the three monitors 108 which are off would, if on, display windows 202 related to the trading software 102. Let's also assume the trader is working in Microsoft Word on the one monitor 108 that is on. If the user was typing on a keyboard 106 into Microsoft Word, and then all of a sudden, a message box popped up within the trading software 102, the trader might not even be aware of this fact. The user might continue typing, only to realize that the keys were no longer having an effect on the Microsoft Word application. The user might then start trying different things to fix the problem, or might just continue to press hotkeys on the keyboard 104. Little does the trader know that the trading software 102 might have sent numerous orders, or executed numerous other functions associated with hotkeys. The user might be building a position worth hundreds of thousands of dollars or more without even knowing it. It is especially important to recognize how significant the unintended effects may be by remembering that the hotkeys may be single keys (e.g., individual letters, numbers, etc.).

Aside from the scenarios described above, it only has to be pointed out that for traders that like to keep multiple applications running on their computer at once, such as streaming news services, charting software, or any other applications, will only serve to cause hotkey functionality to become less predictable. This is because whether users unintentionally switch between applications, or whether they intentionally switch between applications but forget to switch back to the trading software 102 when they want to place trades.

Using traditional trading software and prior systems, functions associated with hotkeys are only executed when the particular trading application is the active application. For example, if traditional trading systems were implemented in FIGS. 3-5, the hotkeys would not execute their associated actions, because the trading software 102 is not the active application. However, it is in FIGS. 3-5 that the presently disclosed subject matter differentiates itself. This is because in the disclosed system 100, any hotkey action that has been executed within the system 100 results in the associated actions within the trading software 102 being triggered, as long the actions have been defined in the trading software 102 and as long as the hotkey subscriptions are turned on, as described further herein.

In the examples provided in FIGS. 1-5 there are multiple windows 202 as part of one trading application 102, which is a rather common occurrence for trading applications 102. The examples given display multiple windows 202 as part of a trading application 102 specifically to demonstrate how even if there are few applications running on the system 100, it may still be quite difficult, annoying, and time consuming for the user to search for the active application, whether the user looks at the title bars 204 or in the taskbar 208. Also note that in scenarios where the user has a large number of applications or windows 202 within applications running, the taskbar 208 might not even have enough room to show all of the applications. This could make the use of the taskbar 208 more difficult, if not sometimes impossible.

Referring back to FIG. 2, there is a second window 202b and a third window 202c, each of which is associated with a corresponding tradable instrument. As further shown, each window 202b and 202c includes a hotkey subscription toggle button 214. It is via these toggle buttons 214 that the user is able to separately turn the hotkey subscriptions on or off for each tradable instrument. In the example given in FIG. 2, there are two distinct tradable instruments; however, it is understood that there may be any other number of one or more tradable instruments. Additionally, there may further be other types of buttons which, instead of turning hotkey subscriptions on or off for one tradable instrument at a time, may do so for multiple tradable instruments at a time, such as all of these that fall within a similar category such as an exchange or a industry. There may also be a button (or other type of input) which will allow the user to turn on or off the hotkey subscriptions for all of the functionality within the trading software 102 in one input command. In the example provided, the subsets are delineated by the tradable instruments (a first subset of hotkeys related to a first tradable instrument and a second set of hotkeys related to a second tradable instrument), the subset grouping and delineation may be made in any manner. For example, a subset may include: all futures contracts with the same last trading day; all order entry functions across all tradable instruments; all non-order entry functions across all tradable instruments; all hotkeys which perform specific types of functions; or any other subsets. Accordingly, it can be understood that the hotkey subscriptions are configurable to be turned on and off as any number of one or more subsets of the complete hotkey set.

As discussed above, a trader may have the trading software 102 opened in the system 100, but may wish to work in another application for a while maintaining the ability to start trading again very quickly. As can be seen in the example shown in FIGS. 4 and 5, the user may have multiple applications opened on the system 100, which may include the trading software 102, a charting package, Microsoft Excel, and any other applications. Because the present system 100 allows the trader to turn on or off the hotkey subscriptions, i.e., turn on or off whether or not the trading software is informed when a hotkey which has been assigned to functionality in the trading software has been triggered, the trader to better use other applications without risk for errors within the trading software 102, as well as other benefits such as ease of switching between applications without risk for error.

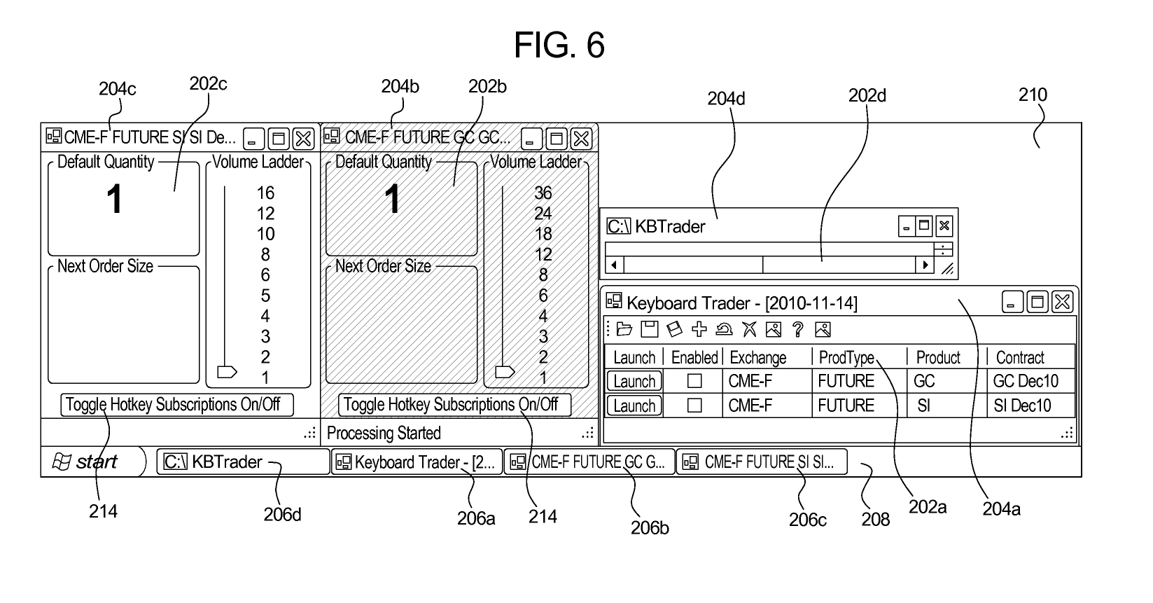

Turning now to FIG. 6, the second window 202b is shown as being highlighted (denoted by the background shading in the second window 202b) to denote that all of the hotkeys associated with the tradable instrument associated with the second window 202b are active. Any number of hotkeys may be associated with a given tradable instrument, depending on the trading software 102 and the user's preferences or specific setup. The highlighting shown is merely one contemplated indicia that may be used to denote the hotkeys are active for a given tradable instrument. It is contemplated that a preferred embodiment of the system 100 may utilize indicia including a bright color (such as, for example, a bright green) for the highlighting to increase the contrast and draw attention to the hotkey subscription status.

As described above with respect to the Figs., in instances where there are two or more software applications running within the system 100, the trading software 102 is informed by the one or more controllers 104 when one or more hotkeys which are associated with one or more functions in the trading software 102 are triggered, even when the trading software 102 is not an active software application. In some of these instances, a second software application may be an active application and in other instances no application may be active.

In instances in which a second application includes overlapping hotkeys (hotkeys that are associated with functions in both the trading software 102 and the second application) the system 100 may be configured to inform both applications that the hotkey has been triggered or may be configured to only inform the trading software 102. This holds true no matter how many applications are running or active in the system 100. Accordingly, as described, the trading software 102 hotkeys may precede or supersede any hotkeys in any number of secondary applications.

In the examples provided, the application state has been referenced as either active or inactive for the trading software 102 and for other applications. In order to enhance reader understanding, we have often referred to this topic of the application being active or inactive while making reference to whether the user has left-clicked or right-clicked the desktop 210, or whether the title bar 204 or taskbar 208 is highlighted. It should be noted that even though these explanations are fairly reliable on many operating systems, it is possible that with other operating systems and in other scenarios, the application state may be based on other criteria. Further, application state may make itself known in other ways.

Further, the drawings shown are examples based on a current Windows operating system environment. Even though Windows is a commonly used operating system, other operating systems exist. Other operating systems, and also future versions of Windows operating systems, may allow application state to be determined in different ways, may allow application state to be made known to the user in different ways, and other derivations may exist.

It should be noted that various changes and modifications to the presently preferred embodiments described herein will be apparent to those skilled in the art. Such changes and modifications may be made without departing from the spirit and scope of the present invention and without diminishing its attendant advantages.

I claim:

1. A system for managing hotkey subscriptions comprising:
one or more controllers adapted to run two or more software applications, including a trading software application, wherein the trading software application includes one or more functions associated with a respective one or more hotkeys and further wherein the one or more controllers are configured to inform the trading software application when any of the hotkeys are triggered anytime the trading software application is running.

2. The system of claim 1 wherein the two or more software applications includes a second software application other than the trading software application, wherein the second software application includes one or more functions associated with a respective one or more hotkeys, further wherein at least one of the hotkeys that trigger functions within the second software application is a hotkey that triggers a function within the trading software application.

3. The system of claim 2 wherein the second software application is not informed when the one or more overlapping hotkeys are triggered.

4. The system of claim 1 wherein the one or more controllers may be configured in a first state to execute the one or more functions associated with the respective one or more hotkeys when the hotkeys are triggered.

5. The system of claim 4 further wherein the one or more controllers may be configured in a second state not to execute the functions associated with hotkeys when the hotkeys are triggered.

6. The system of claim 5 wherein the one or more controllers are selectively configured between the first state and the second state based on one or more conditional tests.

7. The system of claim 6 wherein the one or more conditional tests includes one or more conditional logic tests.

8. The system of claim 6 wherein the one or more conditional tests includes one or more user selected conditions.

9. The system of claim 3 further including a user executable function for toggling the one or more controllers between the first state and the second state.

10. The system of claim 9 wherein the functions associated with hotkeys are divided into at least two subsets, wherein each of the subsets of hotkeys may be independently toggled between the first state and the second state.

11. A method for managing hotkey subscriptions, the method comprising the steps of:
concurrently running two or more software applications, including a first trading software application including one or more functions associated with a respective one or more hotkeys; and
informing the first trading software application when any of the hotkeys are triggered, anytime the trading software application is running.

12. The method of claim 11 further comprising the step of executing the triggered one or more hotkeys anytime the trading software application is running.

13. The method of claim 11 further comprising the step of conditionally executing the triggered one or more hotkeys.

14. The method of claim 13 wherein the triggered one or more hotkeys are selectively executed based on one or more conditional tests.

15. The method of claim 14 wherein the triggered one or more hotkeys are automatically selectively executed based on one or more conditional tests.

16. The method of claim 14 wherein the one or more conditional tests include one or more conditional logic tests.

17. The method of claim 14 wherein the one or more conditional tests include one or more user selected conditions.

18. The method of claim 11 wherein the functions associated with hotkeys are divided into at least two subsets, wherein each of the subsets of hotkeys may independently be toggled between a first state in which the associated hotkey subscriptions are on and a second state in which the associated hotkey subscriptions are off.

19. Computer readable media including computer-executable instructions for managing hotkeys subscriptions, the computer-executable instructions causing a system to perform the steps of:
concurrently running two or more software applications, including a first trading software application including one or more functions associated with a respective one or more hotkeys; and
informing the first trading software application when any of the hotkeys are triggered, anytime the trading software application is running.

20. The computer readable media of claim 19 wherein the computer-executable instructions further cause the system to perform the steps of executing the triggered one or more hotkeys anytime the trading software application is running.
